(19) United States
(12) Patent Application Publication
(10) Pub. No.: US 2010/0153232 A1
(43) Pub. Date: Jun. 17, 2010

(54) Electronic Kiosks for Ordering Custom Photographic Frames

(76) Inventors: Carl Ettlinger, Chesterfield, MO (US); Nancy Neiman, Chesterfield, MO (US)

Correspondence Address: HARNESS, DICKEY, & PIERCE, P.L.C, 7700 Bonhomme, Suite 400, ST. LOUIS, MO, 63105, US

(21) Appl. No.: 12/502,521

(22) Filed: Jul. 14, 2009

Related U.S. Application Data
(60) Provisional application No. 61/080,509, filed on Jul. 14, 2008.

(51) Int. Cl. G06Q 30/00; G06Q 50/00; G06F 15/16; H04N 1/04; G06F 3/048

(52) U.S. Cl. 705/27; 709/201; 358/474; 715/764

(57) ABSTRACT

A method for selling a custom frame to a consumer via an electronic kiosk substantially dedicated to goods and services related to photographic images is disclosed. The method includes receiving a purchase order for a custom frame from the electronic kiosk and transferring the purchase order to a custom framing facility for producing the custom framing.

### CROSS-REFERENCE TO RELATED APPLICATIONS

This application claims the benefit of U.S. Provisional Application No. 61/080,509 filed Jul. 14, 2008, the entire disclosure of which is incorporated herein by reference.

### FIELD

The present disclosure relates to electronic kiosks and methods for ordering a custom frame for a photograph.

### BACKGROUND

The statements in this section merely provide background information related to the present disclosure and may not constitute prior art.

Electronic kiosks are generally known for receiving orders for goods and services related to photographic images from consumers that physically interact with the electronic kiosk. Specifically, it is known to provide a photographic image to a kiosk via a flash memory device, a floppy disk, or a scanner used with a traditional photograph. The electronic kiosks may print the photographic images for the consumer or provide the photographic images to a printing facility, which generally make the traditional photographs ready for pick-up at a later date. The electronic kiosk may also provide a point of sale for personalized objects, such as mugs, puzzles, clothing, and ornaments, with the photographic image printed thereon.

### SUMMARY

According to one aspect to the present disclosure, a method for selling a custom frame to a consumer via an electronic kiosk substantially dedicated to goods and services related to photographic images is disclosed. The method includes receiving a purchase order for a custom frame from the electronic kiosk and transferring the purchase order to a custom framing facility for producing the custom framing.

According to another aspect of the present disclosure, an electronic kiosk for ordering a custom frame for a photographic image provided by a consumer is disclosed. The electronic kiosk includes a display device for displaying at least one size option, at least one matte option, and at least one frame option to a consumer, an input device for receiving at least one input from the consumer for completing a purchase order, an output device for transferring a purchase order including a selected size option, a selected matte option, and a selected frame option for the photographic image to a third-party, and a printer for printing a photographic print of the photographic image. The electronic kiosk is substantially dedicated to goods and services related to photographic images provided by a consumer that physically interacts with the electronic kiosk.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram of a method for selling custom frames according to one embodiment of the present disclosure.

FIG. 2 is an electronic kiosk for ordering goods and services related to a photographic image according to one embodiment of the present disclosure.

FIG. 3 is a flow diagram illustrating a method for selling a custom frame for a photographic print.

### DETAILED DESCRIPTION

The following description is merely exemplary in nature and is not intended to limit the present disclosure, application, or uses.

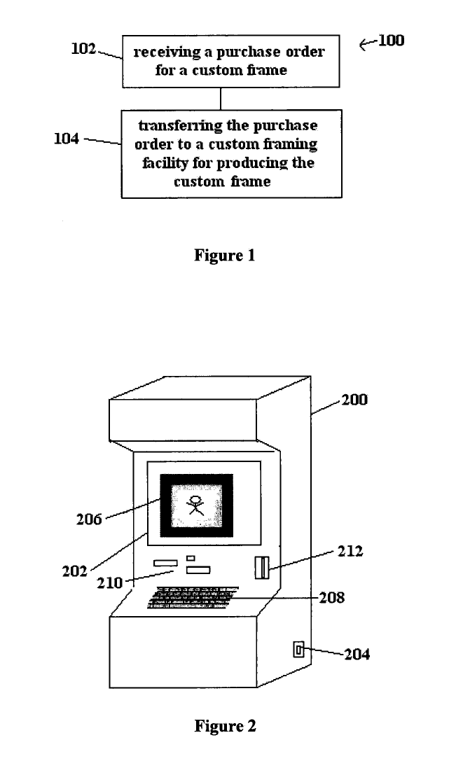

According to one embodiment of the present disclosure, a method for selling a custom frame to a consumer via an electronic kiosk substantially dedicated to goods and services related to photographic images is illustrated in FIG. 1 and generally referenced by numeral 100. The method includes receiving a purchase order for a custom frame from the electronic kiosk at 102 and transferring the purchase order to a custom framing facility for producing the custom framing at 104.

The purchase order generally includes sufficient information for the custom framing facility to produce the custom frame that is the subject of the purchase order. For example, a purchase order can indicate the size option, matte option, and frame option. The size option allows the consumer to select a particular size of photographic print to be included in the consumer frame, which generally affects the size of the matte, if any, and the frame to be made. Size options may include traditional sizes, e.g., 3×5, 4×6, 5×7, 8×10, 27×41 or other specific sizes entered by the consumer, both standard and custom.

The matte option may provide a variety of different color, style, and texture options to the consumer. Dimensions of the matte, such as width, may also be selected by the consumer or dictated by the selected size option. An option may further be included for multiple mattes. And, in some embodiments, the matte option may include an option for no matte.

The frame option provides the consumer with a number of different frame types, colors, shapes, and styles. For example, the frame may be wood, metal or plastic, and offered in an assortment of different styles, such as contemporary, economy, traditional, sports, etc. The shape of the frame may also be an option to the consumer. For example, square, rectangular, circular, triangular, trapezoidal, and ovular options can be available for selection by the consumer depending on the consumer's particular taste and/or the photographic print to be included in the custom frame. Dimensions of the custom frame may be dictated by the size option described above, or in some embodiments, the dimensions of the custom frame may be received from the consumer.

Each of the size, matte, and frame options available to the consumer are generally displayed to the consumer via the electronic kiosk. Ultimately, the photographic image with the selected size option, matte option, and frame option is displayed to the consumer for either approval or alteration. At this point, the consumer may complete the purchase order.

When the purchase order is completed, the consumer may have options regarding where the finished custom frame is delivered. In some embodiments, a consumer may have the finished custom frame delivered, mailed or shipped to one of the consumer's residence or a location associated with an operator of the electronic kiosk. The consumer may select one of the options for delivery based on convenience and/or cost saving. For example, an operator of the electronic kiosk may offer cost savings for consumer who picks-up the finished custom frame from the location associated with an operator of the electronic kiosk. The operator of the electronic kiosk may be a retailer or other type business providing public access to the electronic kiosk.

The method described above can be employed in a number of different embodiments of electronic kiosks. One example for an electronic kiosk for implementing the method described above is illustrated in FIG. 2. The electronic kiosk 200 includes a display device 202 displaying size options, matte options, and frame options to a consumer, an input device for receiving an input from the consumer, and an output device 204 for completing a purchase order and an output device for transferring a purchase order including the size, the matte, and the frame options for a photographic image provided by the consumer to a third-party. The display device 202 of the electronic kiosk 200 is displaying a photographic image with the custom frame 206 selected by the consumer.

In this particular embodiment, the input device includes a keyboard 208 and a touch-screen display device 202. In this manner, the consumer can complete a purchase order by supplying an input to the keyboard, the touch-screen display device, or a combination of both. It should be appreciated that other types and combinations of input devices may be used in other embodiments of the present disclosure. For example, in some embodiments, a touch-screen display device may be the only input device for a consumer to complete a purchase order (i.e., not including one or more input devices for uploading photographic images). In another example, a number of keys may be positioned proximal to the display device, so that options may be associated with each of the keys via the display device.

The output device may be any type of device for communication with an area network, such as a modem, network interface card, wireless internet card, etc. The area network may be a wide area network (WAN) or a local area network (LAN) depending on the particular implementation in which the kiosk is employed. The output device 204 included in FIG. 2 is a network interface card, which facilitates transfer of the purchase order through a wide area network. In another embodiment, an output device of an electronic kiosk includes a printer, which generates paper purchase orders that are transferred via hand-delivery or US mail.

The electronic kiosk 200 also includes three input devices 210 for uploading photographic images to the electronic kiosk 200. The electronic kiosk 200 includes three input devices 210 to accommodate the multiple different types of media devices in which consumers may transport a photographic image. For example, a consumer may have a flash card from a digital camera or a USB “thumb-drive” or a floppy disk with photographic images from a personal computer. Further, the sizes and shapes of flash cards often vary by camera size and manufacturer, therefore the number and type of input devices may be selected to accommodate the largest number or most popular types of media devices. Other criteria, such as kiosk design, may also impact the number and type of input devices included for uploading photographic images. In some embodiments, the input device includes a network interface card (which may be integrated with the output device). In this manner, the consumer can retrieve one or more photographic images via an area network, such as the internet and/or World Wide Web.

The electronic kiosk 200 further includes input device 212 for receiving credit card payment from the consumer. When the purchase order is completed by the consumer, the display device 202 prompts the consumer for payment. The consumer can choose to complete payment via sliding a credit card through input device 212 or to make payment when picking up the finished custom frame from the operator of the electronic kiosk. In other embodiments, the method of payment may include one or more of credit cards at the electronic kiosk, payment to an operator, billing to the consumer's residence, or another payment option.

In another embodiment of the present disclosure, an electronic kiosk includes a printer for printing a photographic print from a photographic image received by the electronic kiosk. A consumer may print a photographic print for which a custom frame is ordered or other photographic images received by the electronic kiosk. In other embodiments, an electronic kiosk may receive photographic images and transfer the photographic images to a local location or a remote location for processing. The consumer is permitted to pick up the photographic print from the processing at a later time and/or date.

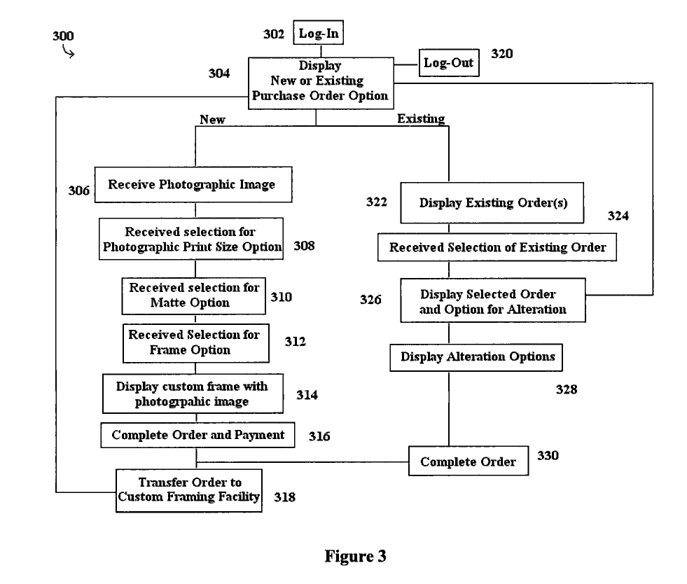

A method 300 according to another embodiment of the present disclosure is illustrated in FIG. 3. The method 300 may be implemented on electronic kiosk 200 or another suitable electronic kiosk within the teachings of the present disclosure. Method 300 includes receiving log-in information for the consumer account, such as a username and password, from a consumer at 302. The consumer can enter an existing consumer account or, if the consumer is a first time consumer, the consumer can create a new user account.

Once the consumer accesses a user account, the electronic kiosk displays an option for a new purchase order or an existing purchase order at 304. When the electronic kiosk receives an input from the consumer indicating the new purchase order option, the consumer is prompted to provide a photographic image at 306. The photographic image, which is an electronic version, may be received via one of input devices 210 or, in some embodiments, by a scanner device which generates a photographic image from a photographic print placed on the scanner device. In other embodiments, an electronic kiosk is configured to receive film, which the electronic kiosk is able to convert to one or more photographic images.

When the electronic kiosk receives the photographic image, options for size, matte, and frame are consecutively displayed to the consumer at 308, 310, and 312. As each option is selected, the photographic image is displayed on the display device with the selected option, such that the consumer may review the selected option. It should be appreciated that an order in which options are displayed to the consumer may be different in other embodiments of the present disclosure. Further, additional options may also be displayed to the consumer for completing an order for a custom frame for the photographic image. For example, options for paper upon which the photographic image is printed and glass type used in the custom frame may be displayed to the consumer. The glass options may include, for example, plexiglass, non-glare plexiglass, regular glazing, glass, UV-filtering glass, etc.

Once all the options selected by the consumer are received by the electronic kiosk, the photographic image with all the received options is displayed to the consumer with all the selected options at 314. If the consumer is not satisfied with any of the options, the consumer can go back to select one or more different options. At 316, the consumer is prompted to complete the purchase order for the custom frame ultimately displayed at 314. When the electronic kiosk receives the completed purchase order, payment options may be displayed to the user as described above. At 318, the purchaser order is transferred to a custom framing facility. In addition to the options selected by the consumer, the purchase order often includes the photographic image for printing and inclusion in the custom frame to be delivered to the consumer. In this embodiment, the purchase order is transferred directly to the custom framing facility. In other embodiments, a purchase order may be routed through another entity, such as the operator of the electronic kiosk, before eventually reaching the custom framing facility. After the purchase order is transferred at 318, the electronic kiosk returns to 304. At 304, the consumer may chose to logout at 320, enter a new purchase order, or view an existing purchase order.

When the electronic kiosk receives a consumer input to view an existing purchase order, all the purchase orders associated with the consumer account are displayed at 322. The consumer may provide an input to the electronic kiosk for selecting one of the purchase orders displayed. At 324, the electronic kiosk receives the input from the consumer, and at 326 displays the selected purchase order. The consumer may simply review the purchase order or make alterations to the purchase order at 328. If the consumer wants to make alterations, a predetermined interval will generally exist from the time the purchase order was originally transferred to the custom framing facility in which the consumer may alter the purchase order. After that predetermined time, the purchase order may not be available for alteration, because production of the custom frame has been started. If the purchase order is available for alteration, the consumer will generally be able to make changes to any of the options previously selected. Once the alterations are complete, the purchase order is again completed at 330, with or without further payment, and transferred to the custom framing facility at 318. The consumer is then returned to 304, which displays options for purchase orders or logout at 320.

In another embodiment of the present disclosure, a computer readable medium has computer-executable instructions stored thereon for performing one or more of the methods described herein.

Although several aspects of the present invention have been described above with reference to electronic kiosks, it should be understood that various aspects of the present disclosure are not limited to electronic kiosks, and can be applied to a variety of other devices for ordering goods and service for photographic images.

By implementing any or all of the teachings described above, a number of benefits and advantages can be attained including improved system reliability, reduced system down time, elimination or reduction of redundant components or systems, avoiding unnecessary or premature replacement of components or systems, and a reduction in overall system and operating costs.

What is claimed:

1. In an electronic kiosk substantially dedicated to receiving orders for good and services related to photographic images from consumers that physically interact with the electronic kiosk, the improvement comprising the electronic kiosk configured to receive a purchase order for a custom frame for a photographic print.

2. The electronic kiosk of claim 1 wherein the electronic kiosk is configured to transfer the purchase order to a custom framing facility.

3. The electronic kiosk of claim 2 wherein the purchase order includes a size option, a matte option, and a frame option for the custom frame.

4. A method for selling a custom frame to a consumer via an electronic kiosk substantially dedicated to receiving orders for goods and services related to photographic images, the method comprising receiving a purchase order for a custom frame from the electronic kiosk and transferring the purchase order to a custom framing facility for producing the custom frame.

5. The method of claim 4 wherein the purchase order is transferred via an area network.

6. The method of claim 4 wherein the purchase order includes a selected size option, a selected matte option, and a selected frame option.

7. The method of claim 4 further comprising displaying the photographic image with a selected matte option and a selected frame option.

8. The method of claim 4 further comprising shipping the custom frame to the consumer at one of a residence of the consumer and a location associated with an operator of the electronic kiosk.

9. A computer readable medium storing computer-executable instructions for performing the method of claim 4.

10. An electronic kiosk for ordering a custom frame for a photographic image provided by a consumer, the electronic kiosk comprising a display device for displaying at least one size option, at least one matte option, and at least one frame option to a consumer, an input device for receiving at least one input from the consumer for completing a purchase order, an output device for transferring a purchase order including a selected size option, a selected matte option, and a selected frame option for the photographic image to a third-party, and a printer for printing a photographic print of the photographic image, the electronic kiosk being substantially dedicated to goods and services related to photographic images provided by a consumer that physically interacts with the electronic kiosk.

11. The electronic kiosk of claim 10 wherein the input device permits access to a consumer account for viewing and/or altering the purchase order.

12. The electronic kiosk of claim 10 wherein the purchase order includes at least one of a paper option and a glass option.

13. The electronic kiosk of claim 10 further comprising a scanning device for generating a photographic image from a photographic print.
